(19) United States
(12) Patent Application Publication
(10) Pub. No.: US 2011/0068973 A1
(43) Pub. Date: Mar. 24, 2011

(54) Assimilating GNSS Signals to Improve Accuracy, Robustness, and Resistance to Signal Interference

(75) Inventors: Todd E. Humphreys, Austin, TX (US); Brent M. Ledvina, San Francisco, CA (US); William J. Bencze, Half Moon Bay, CA (US); Bryan T. Galusha, San Francisco, CA (US); Clark E. Cohen, Washington, DC (US)

(73) Assignee: COHERENT NAVIGATION, INC., San Mateo, CA (US)

(21) Appl. No.: 12/889,242

(22) Filed: Sep. 23, 2010

Related U.S. Application Data
(60) Provisional application No. 61/245,658, filed on Sep. 24, 2009.
(60) Provisional application No. 61/245,652, filed on Sep. 24, 2009.
(60) Provisional application No. 61/245,655, filed on Sep. 24, 2009.

(51) Int. Cl. G01S 19/47; G01S 19/38; G01S 19/46

(52) U.S. Cl. 342/357.3; 342/357.21; 342/357.29

(57) ABSTRACT

A method for upgrading GNSS equipment to improve position, velocity and time (PVT) accuracy, increase PVT robustness in weak-signal or jammed environments and protect against counterfeit GNSS signals (spoofing). A GNSS Assimilator couples to an RF input of existing GNSS equipment, e.g., a GPS receiver, and extracts navigation and timing information from available RF signals, including non-GNSS signals, or direct baseband aiding, e.g., from an inertial navigation system, frequency reference, or GNSS user. The Assimilator fuses the diverse navigation and timing information to embed a PVT solution in synthesized GNSS signals provided to a GNSS receiver RF input. The code and carrier phases of the synthesized GNSS signals are aligned with those of actual GNSS signals to appear the same at the target receiver input. The Assimilator protects against spoofing by continuously scanning incoming GNSS signals for signs of spoofing, and mitigating spoofing effects in the synthesized GNSS signals.

### CROSS-REFERENCE TO RELATED APPLICATIONS

This application claims priority to provisional application Nos. 61/245,658, filed Sep. 24, 2009, titled “Augmenting GNSS User Equipment to Improve Resistance to Spoofing”; 61/245,652, filed Sep. 24, 2009, titled “Simulating Phase-Aligned GNSS Signals”; and 61/245,655, filed Sep. 24, 2009, titled “Assimilating GNSS Signals to Improve Accuracy, Robustness, and Resistance to Spoofing”, which are incorporated herein in their entirety by reference.

### TECHNICAL FIELD

This invention relates to GNSS navigation and more particularly to GNSS security and signal integrity.

### BACKGROUND

There exist, in both military and civil sectors, hundreds of thousands of Global Navigation Satellite System (GNSS) receivers that are susceptible to signal jamming or other signal obstructions, rendering them immediately inoperable. Many of these receivers are also vulnerable to spoofing, a pernicious type of intentional interference whereby a GNSS receiver is fooled into tracking counterfeit GNSS signals. In many cases, the GNSS receivers are coupled to avionics, communication, measurement, or other equipment that depends crucially on the timing signals or navigation data provided by the GNSS receiver. When the steady stream of position, velocity, and time (PVT) data on which this equipment relies is interrupted due to signal obstruction or jamming, the dependent equipment can cease to function or can malfunction with potentially serious consequences.

Apart from their vulnerability to signal obstruction, jamming, and other interference such as spoofing, most legacy GNSS receivers are incapable of tracking modern GNSS signals and so cannot take advantage of the higher accuracy and availability these signals offer.

Accordingly, improvements are sought in GNSS signal security and GNSS receiver compatibility.

### SUMMARY

A method is presented for upgrading existing Global Navigation Satellite System (GNSS) user equipment, with little or no hardware or software modifications to the equipment. In various applications, the method can improve the equipment's position, velocity, and time (PVT) accuracy, increase the equipment's PVT robustness in weak-signal, jammed or other interference environments. In some applications, the method is embodied in a device, termed “the GNSS Assimilator” or simply “the Assimilator,” that couples to the radio frequency (RF) input of existing GNSS equipment, such as a GPS receiver. The Assimilator extracts navigation and timing information from available RF signals, including non-GNSS signals, and from direct baseband aiding provided, for example, by an inertial navigation system, a frequency reference, or the GNSS user. The Assimilator optimally fuses the collective navigation and timing information to produce a PVT solution, which, by virtue of the diverse navigation and timing sources on which it is based, is highly accurate and inherently robust to GNSS signal obstruction and jamming. The Assimilator embeds the PVT solution in a synthesized set of GNSS signals and injects these into the RF input of a target GNSS receiver for which an accurate and robust PVT solution is desired.

The code and carrier phases of the synthesized GNSS signals can be aligned with those of the actual GNSS signals at the input to the target receiver. Such phase alignment causes the synthesized signals to appear the same as the authentic signals to the target receiver, which equivalence enables a user to “hot plug” the Assimilator into a target receiver without interruption in PVT. Besides improving the PVT accuracy and robustness of the target receiver, the Assimilator can also be used to protect the target receiver from GNSS interference, for example by continuously scanning incoming GNSS signals for signs of spoofing, and, to the extent possible, eliminating spoofing or other interference effects from the synthesized GNSS signals.

In some implementations, one aspect of the invention features a method for generating a set of radio-frequency GNSS signals. The method includes receiving a plurality of signals, each signal bearing one or more navigation usable observables or timing usable observables and estimating a first navigation solution based on the observables from the plurality of signals. The method further includes generating a plurality of simulated radio-frequency GNSS signals defining a second navigation solution substantially consistent with the first navigation solution.

In some applications, the one or more observables include at least one of a code phase, carrier phase, carrier frequency, navigation data bit sequence phase, and correlation function profile.

In some applications, at least one of a plurality of signals is a non-GNSS signal.

In some applications, the one or more observables include at least one of signal time-of-arrival, signal angle-of-arrival, carrier frequency, and data bit sequence phase.

In some applications, the second navigation solution is based in part on a signal processing observable of a radio-frequency signal that is not expressly classified as a radionavigation signal.

In some applications, the radio-frequency signal contains navigation-or-time-bearing signatures, including at least one of time of arrival, carrier frequency, and data bit sequence phase.

In some applications, the method includes receiving position, velocity, and acceleration observables from a local inertial measurement unit.

In some applications, the method includes receiving time data from a local reference clock.

In some applications, the method includes receiving position, velocity, and time data from a user input.

In some applications, the second navigation solution is obtained using a sequential nonlinear least-squares estimator (i.e., extended Kalman filter) to fuse one or more GNSS observables. In some instances, the second navigation solution is obtained using a sequential nonlinear least-squares estimator to fuse one or more non-GNSS observables. In some instances, the method includes fusing a non-GNSS observable with the GNSS observables to obtain the second navigation solution.

In some applications, the method includes relating an antenna position and velocity and receiver time to at least one GNSS observable or non-GNSS observable.

In some applications, the method includes inputting the simulated GNSS signal into a GNSS receiver.

In some applications, the plurality of signals includes exclusively non-GNSS signals.

In some applications, the plurality of signals includes a communications network signal.

In some applications, the method includes aligning both a carrier phase and a code phase of the synthesized GNSS signal with a carrier phase and a code phase of one or more ambient radio-frequency GNSS signals at a predetermined three-dimensional position offset and a predetermined velocity offset relative to a predetermined reference location.

In some applications, the synthesized GNSS signals compensate for at least one of a jammed GNSS signal, a weak GNSS signal, a counterfeit GNSS signal, and a compromised GNSS signal.

In some applications, the method includes receiving a baseband signal bearing at least one of time, position and velocity data. In some cases, the baseband signal comprises one of an inertial navigation system signal, a frequency reference signal, and a user input.

In some applications, an output signal is compliant with a single-frequency narrowband target GNSS receiver. In some applications, the synthesized signals are formed to be compliant with a legacy GNSS receiver. In some applications, the assimilator is integrated into a GPS receiver. In some applications, the assimilator is a stand-alone device.

In some implementations, another aspect of the invention features a GNSS signal assimilator including a signal receiver configured to receive a plurality of signals and extract at least one code observable corresponding to each of the plurality of signals. A navigation and timing fusing module is configured to render, from the code observables, time and position data, and to calculate a first navigation solution based on the rendered data. A signal simulator module configured to synthesize a plurality of GNSS signals that collectively define a second navigation solution substantially consistent with the first navigation solution.

In some implementations, the signal receiver is further configured to extract a carrier observable from each of the plurality of signals. In some instances, the carrier observable is at least one of a carrier phase observable and a carrier frequency observable. In some instances, the first navigation solution comprises velocity data.

In some implementations, the GNSS signal receiver is a multi-system receiver module configured to receive a non-GNSS signal and wherein the navigation and timing fusion module is configured to render time, position, or velocity data from the non-GNSS signal.

In some implementations, the navigation and timing fusion module is configured to render a navigation solution using time, position or velocity data rendered primarily or exclusively from one or more non-GNSS signals. In some implementations, the one or more non-GNSS signals include at least one of a television signal, communications network signal, HDTV signal, LORAN signal, ELORAN signal, Radar signal, and IRIDIUM™ signal.

In some implementations, the synthesizing module outputs a legacy GNSS receiver compliant signal.

In some implementations, the GNSS signal receiver is configured to receive the plurality of GNSS signals via an RF input.

In some implementations, the GNSS signal assimilator includes an RF output and wherein the synthesizing module is configured to output the second navigation solution as an RF GNSS signal.

In some implementations, the GNSS signal assimilator includes a reference oscillator operably coupled to the synthesizing module. In some instances, the GNSS signal assimilator is configured to align both a carrier phase and a code phase of the synthesized GNSS signal respectively with a carrier phase and a code phase of one or more ambient radio-frequency GNSS signals at a predetermined three-dimensional position offset and a predetermined velocity offset relative to a predetermined assimilator reference location.

In some implementations, the GNSS signal assimilator includes an anti-spoofing module operable to continuously analyze data received at the GNSS signal receiver to detect a spoofing signature. In some instances, the anti-spoofing module is configured to detect one of a data bit latency, a vestigial signal, an angle of arrival measured by multiple antennae, and a cryptographic signature. In some instances, the GNSS signal assimilator includes a conversion module comprising a digital-to-analog converter, frequency mixer, signal filters and signal attenuators cooperatively configured to convert a digital signal into the synthesized GNSS signals.

In some implementations, the assimilator is operably connectable to a commercial, stand-alone GNSS receiver.

The Assimilator is a cost-effective alternative to replacing existing user equipment for users who want a PVT solution that is robust against GNSS signal obstruction, jamming, and spoofing, or who want access to the benefits of GNSS modernization.

Thus, the GNSS Assimilator provides for augmenting instead of replacing legacy equipment. The augmentation need not require hardware or software modification to the existing equipment—the Assimilator can simply attach to a GNSS receiver's radio frequency (RF) input port and inject a consistent set of synthesized GNSS signals defining a PVT solution that is robust, accurate, and spoof-free.

The following subsections describe various applications of the GNSS Assimilator in three focus areas: signal obstruction or jamming, spoofing, and GNSS modernization.

### Signal Obstruction or Jamming

When the signal-to-noise ratio within a GNSS receiver falls below a certain threshold, either because the GNSS signal is obstructed or because a jamming attack is underway, the user can be presented with a “need clear view of sky” or similar notice from the receiver. At this point, the receiver-produced PVT data either rapidly deteriorates in accuracy or the data stream abruptly halts. Obviously, a better outcome in such weak-signal or jammed environments would be for the receiver-produced PVT data to deteriorate only mildly, if at all. This is what is meant by robust PVT.

When coupled to the GNSS Assimilator, existing GNSS user equipment would be capable of delivering robust PVT. This is because the Assimilator is not limited to deriving PVT information from, for example, GPS signals. Rather, it behaves opportunistically, extracting navigation and timing information from other RF signals in the environment—including those from other GNSS—or from baseband data sources such as an inertial navigation system, an external synchronization signal, or from the user himself.

Some of the additional RF signals available to the Assimilator can be radionavigation signals (e.g., other GNSS or ELORAN signals) with a signal-to-noise ratio that happens to be higher than those the target receiver is natively capable of tracking, whether because the signals are unobstructed, or intrinsically of higher power, or because their carrier frequency falls outside the jammed frequency range. Yet other available RF signals may not be radionavigation signals as such, but may nonetheless carry implicit navigation or timing data. For instance, television signals, cellular telephone signals, and satellite communication signals can be exploited for navigation and timing.

From available navigation- or time-bearing RF signals, or from baseband data input by the user or by external devices, the Assimilator optimally estimates its PVT state. Consistent with this PVT state, the Assimilator continuously generates a target-receiver-compliant set of RF GNSS signals and injects this into the target receiver's RF input. To generate the synthesized GNSS signals, the Assimilator employs a GNSS signal simulator having timing synchronized to the Assimilator's bank of radionavigation receivers. In some embedded applications, the GNSS signal simulator can be implemented together with the Assimilator's other components on a single digital signal processor.

In one embodiment of the Assimilator, the embedded GNSS signal simulator is a special phase-coherent GNSS signal simulator capable of replicating ambient authentic GNSS signals and phase-aligning to these. Such phase alignment implies that the synthesized signals appear exactly as the authentic signals to the target receiver, which means that the Assimilator can be seamlessly “hot plugged” into a target receiver without interrupting or degrading the target receiver's PVT solution.

In a complete GNSS signal blackout, the PVT data produced by the coupled Assimilator and target receiver will eventually degrade, but by leveraging non-GNSS navigation and timing sources, the Assimilator substantially limits this degradation.

### Spoofing

In some implementations, an optional anti-spoofing or spoofing countermeasure module may be included. Stand-alone commercial civilian GNSS receivers available today may be readily spoofed. One simply attaches a power amplifier and an antenna to a GNSS signal simulator and radiates the RF signal toward the target receiver.

Military-grade GNSS receivers are capable of operating in a spoof-resistant mode in which the receiver tracks an encrypted ranging code with a pattern that is unpredictable except to compliant and keyed user equipment. However, in practice, many military personnel fail to maintain the cryptographic keys in their GNSS user equipment or prefer to carry civil GNSS receivers, with the result that a large fraction of GNSS receivers in military service are vulnerable to spoofing.

An Assimilator including the optional anti-spoofing module can detect the presence of GNSS spoofing by employing spoof detection methods and by validating incoming GNSS signals against other available navigation and timing sources, such as those described in the preceding subsection.

Once the anti-spoofing module detects a spoofing attack, it can alert the user and the Assimilator can exclude the spoofing signals from its internal PVT estimate. The synthesized GNSS signals that the Assimilator continuously sends to the target receiver can thus be made spoof-free, and the target receiver can be protected from the spoofing attack.

In an alternative embodiment, the Assimilator incorporates a full GPS Selective Ability Anti-Spoofing (SAASM) module, providing military-grade spoofing protection to any target receiver, whether military or civil. This option can be advantageous, for example, to military users who demand military-grade security against spoofing but prefer the user-friendly interface of commercial civil user equipment.

In another embodiment, the Assimilator initially acts as a stand-alone spoofing detector, uncoupled from any target receiver. When a spoofing attack is detected, the Assimilator raises an alarm and an unprotected GNSS receiver can then be coupled to the Assimilator for protection against the attack.

This embodiment would be attractive to users who are wary of spoofing but who otherwise prefer an untethered GNSS receiver.

### GNSS Modernization

Modernized GPS offers a ten-fold improvement in civil ranging precision, improved military signal precision and integrity, and greater frequency diversity than legacy GPS. For example, the Russian GLONASS system is rapidly being replenished and will soon reach full operational capability; the Chinese Beidou/Compass system has an ambitious launch schedule that will populate the constellation within the next few years; and, despite some initial setbacks, the European Galileo system will likely be fully deployed within the next decade.

To directly harness the improved accuracy, availability, and redundancy that these modern GNSS offer, military and civilian GNSS users must generally abandon existing equipment as obsolete and replace it, at significant expense, with newer equipment. The Assimilator, however, delivers the benefits of GNSS modernization through augmentation, rather than replacement, of existing user equipment. The Assimilator can be configured to track numerous available modern GNSS signals. From these signals, it estimates a highly accurate PVT solution that it embeds in a set of synthesized GNSS signals with which the target GNSS receiver is natively compliant. The synthesized GNSS signals are generated by the signal simulator mentioned above and injected into the RF input of the target GNSS receiver.

When coupled to a narrowband target GNSS receiver (an L1 C/A GPS receiver, for example), the Assimilator cannot pass on the full ranging precision of modern wideband civil signals such as the GPS L5 and the Galileo E5a and E5b signals. Nonetheless, the Assimilator significantly compensates for this limitation by synthesizing GNSS signals characterized by strong geometry and high signal-to-noise ratio to yield a high-precision PVT solution. Furthermore, the Assimilator is able to pass on the improved multipath immunity and orthogonality that modern GNSS signals offer, and, because it tracks signals at multiple GNSS frequencies, it can substantially eliminate ionospheric errors from the GNSS signals it synthesizes. Considering these benefits, one can readily appreciate that the PVT solution of an Assimilator-aided legacy single-frequency narrowband target receiver will be nearly as accurate as that of a modern multi-frequency wideband GNSS receiver.

Augmentation with the Assimilator is particularly cost-effective where the Assimilator itself is less expensive than replacing existing user equipment with a new model as capable as the Assimilator-receiver pair.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a GNSS navigation system employing auxiliary non-GNSS signals.

FIG. 2 is a block diagram of a GNSS navigation receiver.

FIG. 3 is a functional block diagram of a GNSS Assimilator.

FIG. 4 illustrates a method of using a GNSS Assimilator in the context of signal obstruction or jamming.

FIG. 5 illustrates a method of using a GNSS Assimilator in the context of spoofing.

FIG. 6 illustrates a method of using a GNSS Assimilator in the context of GNSS modernization.

### DETAILED DESCRIPTION

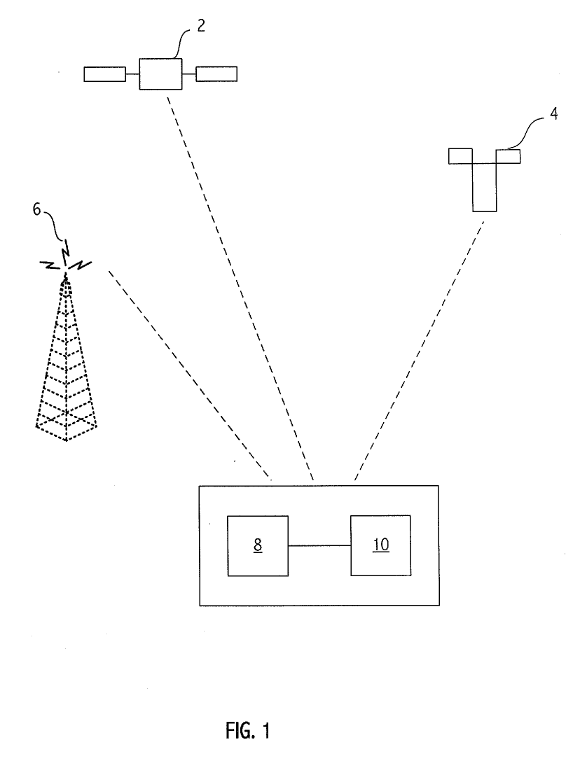

With reference to FIG. 1, a GNSS navigation receiver 10 is capable of providing a positional and/or timing solution based on signals from one or more GNSS satellites 2, non-GNSS satellites 4, and/or terrestrial RF sources 6. A GNSS Assimilator 8 is configured to provide navigation-useful signal data to GNSS navigation receiver 10. GNSS Assimilator 8 can selectively pass signals or signal data on to an RF input of GNSS navigation receiver 10 and can exclude, replace or nullify compromised signal data.

For example, in some applications, the non-GNSS satellite 4 is a LEO satellite, e.g., IRIDIUM™ satellite, providing data useful to GNSS Assimilator 8 in providing timing, positional or navigational solution useful data to GNSS navigation receiver 10.

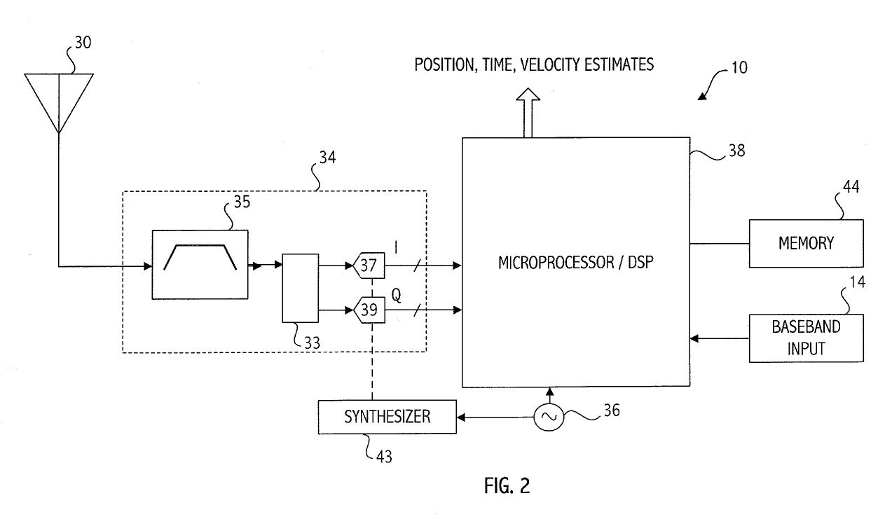

With reference to FIG. 2, basic architecture of a GNSS navigation receiver 10 can include a multi-system antenna 30 to receive the satellite signals and other RF signals, front end 34 including a bandpass filter 35, preamp and a navigation receiver clock 36, e.g., reference crystal oscillator. The RF front-end 34 draws in signals from the multi-system antenna 30 and filters, mixes, and digitizes the signals. The output of the RF front-end 34 is a stream of digital data samples that are routed to the digital signal processor (DSP) 38. Structurally, the DSP 38 processes computer programming instructions stored in memory 44, e.g., to determine navigation radio position. DSP 38 may also receive baseband input such as inertial measurements, a time synchronization pulse, or PVT input from a user.

A synthesizer 43 provides a coherent sine wave and clock signals to be used by other radio components based on a clock signal received by the synthesizer. For example, an inertial sensor provides accelerometer and rate-gyro baseband inputs 14 time tag synchronized to receiver clock 36 and may be used to provide raw digital motion samples. GNSS navigation receiver 10 calculates an estimate of the bias of navigation radio clock 36 to compensate for measured errors in a satellite clock, reference station clock, multiple receiver clocks and/or time slot changes in a transmission sequence and the like. Some implementations include RF front end 34 that downconvert to an intermediate frequency (IF), however, a direct downconversion to baseband may be used.

The RF front-end 34 of the receiver 10 downconverts the received RF signal into an intermediate frequency signal which is output to the DSP 38. The RF front-end 34 can carry out various bandpass, automatic gain control (AGC), direct RF sampling and A/D conversion functions and may use direct or traditional inphase and quadrature downconversion schemes. For example, a hybrid coupler 33 can separate the signal into in-phase and quadrature components and A/D converters 37, 39 can sample incoming in-phase and quadrature signals and output to DSP 38 digital data useful to derive a range observable. For example, DSP 38 can derive at least one of a pseudorange, carrier phase or Doppler shift range observable for a corresponding satellite. DSP 38 can determine a clock offset between navigation receiver clock 36 and a satellite reference clock. DSP 38 may perform any number of routines with received signals or data including extracting ephemeris information for a corresponding satellite.

Memory 44 stores data and computer programming instructions for processing. Memory 44 may be an EEPROM chip, electromagnetic device, optical storage devices, or any other suitable form or type of storage medium. Memory 44 can store, inter alia, ephemerides for the corresponding satellite, local terrain data, and any type of data derived from the received RF signals, inertial sensor or other sensor outputs, user inputs, or other suitable data source. For example, in some cases, satellite ephemerides are transmitted or obtained through other than a satellite signal, e.g., via a ground reference station or over a wireless network connection.

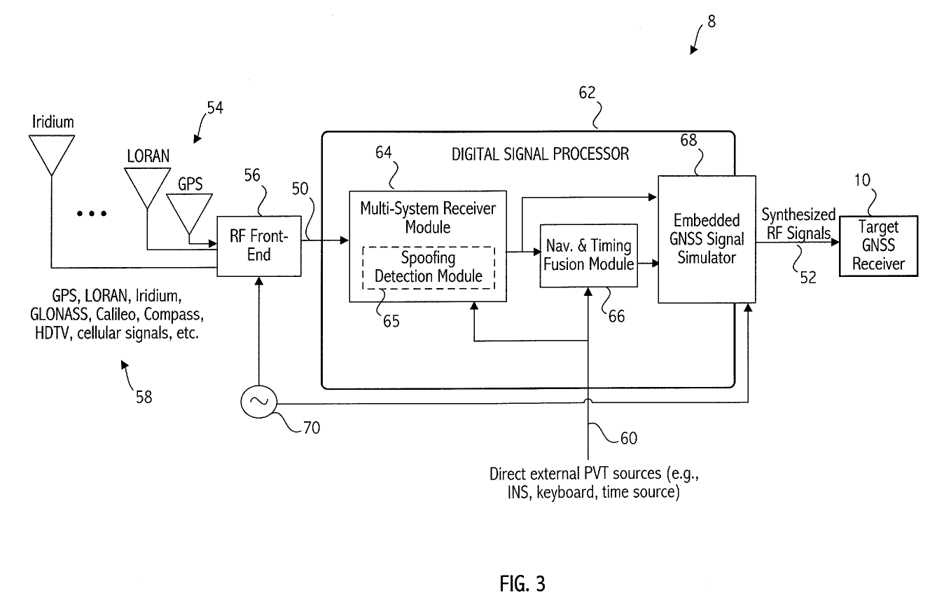

In some implementations, GNSS Assimilator 8 may be implemented or incorporated, at least in part, within receiver 10, e.g., as software instructions operable on DSP 38. With reference to FIG. 3, however, GNSS Assimilator 8 is described as a standalone device connectable to a target GNSS navigation receiver 10. GNSS Assimilator 8 includes one or more input ports 50 and an RF output 52. Antennas 54 connected to the RF front end 56 receive navigation- or time-bearing RF signals 58 present in the GNSS Assimilator environment. Another input 60 may be provided for receiving external PVT information provided at baseband such as inertial measurements, a time synchronization pulse, or PVT input from a user. The GNSS Assimilator RF output 52 is communicatively coupled to the RF input of an existing GNSS navigation receiver 10 (“the target receiver”). GNSS Assimilator 8 may also be coupled to the baseband input 14 of navigation receiver 10.

By extracting navigation and timing information from the incoming RF signals and from the baseband PVT input, and by incorporating an anti-spoofing module 65 (described below), the GNSS Assimilator provides robust and accurate PVT and spoofing protection for the target receiver 10.

In some implementations, the Assimilator comprises:

1) A digital signal processor 62 on which the multi-system receiver module 64, the anti-spoofing module 65, the navigation and timing fusion module 66, and the digital processing component of the embedded GNSS signal simulator 68 are implemented. (The embedded GNSS signal simulator 68 is depicted in FIG. 3 as residing partly outside the digital signal processor 62 because it includes an external RF upconversion component.)

2) A bank of RF front ends 56 that filters, mixes, and digitizes electromagnetic navigation- or time-bearing signals 58 in the vicinity of the Assimilator, signals 58 including, but not limited to:
1. GPS signals
2. Galileo signals
3. GLONASS signals
4. Beidou/Compass signals
5. SBAS signals (e.g., WAAS, EGNOS)
6. LORAN signals
7. ELORAN signals
8. IRIDIUM™ signals
9. HDTV signals
10. Cellular telephone signals
11. WiFi signals
12. NIST timing signals

The output of the RF front-end bank 56 is a stream of digital data samples 50 that is routed to the multi-system receiver module 64. For synchronization, the RF front-end bank 56 and the embedded GNSS signal simulator 68 are tied to a common reference oscillator 70.

3) A multi-system receiver module 64 is capable of processing and extracting navigation and timing data from a diverse set of RF signals with combined digitized data 50 output by the RF front-end bank 56. GNSS carrier and code phase measurements and GNSS carrier frequency measurements produced by the multi-system receiver module 64 are routed to the embedded signal simulator 68 for phase alignment of the synthesized GNSS signals 52. The multi-system receiver module 64 can be a software radio based on techniques such as those described in U.S. Pat. Nos. 7,010,060 and 7,305,021, which are incorporated herein by reference in their entirety.

4) An anti-spoofing module 65 is described subsequently as an optional subcomponent of the multi-system receiver module 64.

5) An optional input port 60 provided for receiving external input, e.g., baseband PVT information (external PVT input). Input data may come, for example, from an inertial navigation system, an external clock, or a keyboard.

6) A navigation and timing fusion module 66 that employs optimal estimation techniques to combine the PVT data from the external PVT input 60 with navigation and timing observables extracted from the various received signals to produce a robust PVT solution that serves as an input to the embedded GNSS signal simulator 68 described below.

7) An embedded GNSS signal simulator 68 is configured to provide synthesized RF signals to a target receiver 10.

The following subsections provide further details on the anti-spoofing module 65 and the embedded GNSS signal simulator 68.

### Anti-Spoofing Module

The anti-spoofing module 65 continuously analyzes the data stream entering the GNSS Assimilator 8 to detect spoofing signatures. If a spoofing attack is detected, the anti-spoofing module 65 asserts an indicator, e.g., an electronic signal, an audible signal or a visual signal, or the like. The anti-spoofing module 65 can employ one or more of the following techniques to detect the presence of spoofing:
1. A data bit latency defense.
2. A vestigial signal defense.
3. A multi-antenna angle-of-arrival defense.
4. A civil GPS cryptographic defense that requires changes to the broadcast GPS signals or the wide-area augmentation signals (WAAS).
5. A civil GPS cryptographic defense that does not require changes to the broadcast GPS signal nor to WAAS.
6. A cryptographic defense based on incorporating a SAASM-type (i.e., military-grade) GPS receiver into the anti-spoofing module.

Anti-spoofing measures are further detailed in Applicants' copending application Ser. No. ______, filed September ______, 2010, and titled “Augmenting GNSS User Equipment to Improve Resistance to Spoofing,” which is incorporated herein in its entirety.

### Embedded GNSS Signal Simulator

In an embedded GNSS signal simulator 68 implementation, a digital signal-processing component can be implemented along with the multi-system receiver module 64 and the navigation and timing fusion module 66 on a single digital signal-processing platform 62. The embedded GNSS signal simulator 68 generates multiple GNSS signals defining a navigation and timing solution consistent with a position, velocity, and time, similar to the operation of a GNSS signal simulator.

In a particular GNSS Assimilator embodiment, the embedded GNSS signal simulator 68 is a specialized phase-coherent GNSS signal simulator. This type of phase-coherent GNSS simulator generates multiple GNSS signals that, if broadcast from the location of the simulator's radio frequency output, would have carrier and code phases that are aligned with the carrier and code phases of the corresponding authentic GNSS signals at a nearby location specified by the user. This specialized phase-coherent capability enables the user to “hot plug” the GNSS Assimilator 8 into a target receiver 10. In other words, the GNSS Assimilator 8 could be coupled with a target receiver 10 that is already tracking or was recently tracking GNSS signals without interrupting or degrading the target receiver's PVT solution. Additional phase coherent implementation details are found in Applicants copending application Ser. No. ______, filed September ______, 2010, titled “Simulating Phase-Coherent GNSS Signals,” which is incorporated herein in its entirety by reference.

### Performance Scenarios

Implementations of the GNSS Assimilator 8 are advantageous in at least the following applications: signal obstruction or jamming, spoofing, and GNSS modernization.

### Signal Obstruction or Jamming

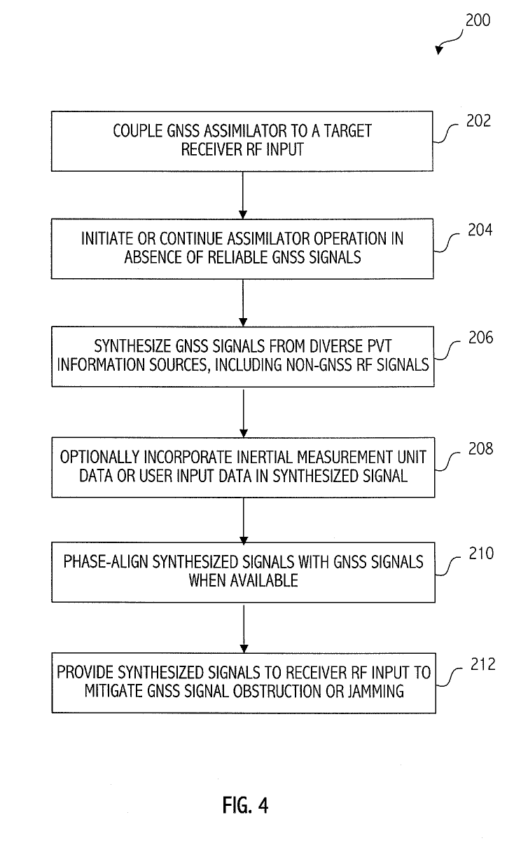

With reference to FIG. 4, a GNSS Assimilator may be used to mitigate signal obstruction or jamming. One method of mitigating GNSS signal obstruction or jamming with a GNSS Assimilator is described. (200) The GNSS Assimilator is coupled to a target receiver RF input. (202) For example, the output port of the GNSS Assimilator may be connected either via a coaxial cable of via wireless RF transmission to either the respective input RF port of the target receiver or the target receiver's antenna. GNSS Assimilator operation may be initiated or continued in the absence of reliable GNSS signals. (204) For example, if no GNSS signals are available due to obstruction or jamming, the GNSS Assimilator can provide a GNSS “flywheel” effect by continuing to provide sufficiently accurate GNSS signals to the target receiver. During operation, the GNSS Assimilator synthesizes GNSS signals from diverse PVT information sources, including non-GNSS RF signals. (206) For example, IRIDIUM™ signals and cellular signals can be used to providing timing and ranging information to the GNSS Assimilator. The GNSS Assimilator can optionally incorporate inertial measurement unit data, user input data or other external baseband data in synthesizing a signal. (208) For example, an IMU or high-quality oscillator can be used to aid the GNSS Assimilator estimation of position, velocity, and time.

In some cases, the synthesized signals may be optionally phase-aligned with ambient GNSS signals when available. (210) Precise carrier phase-alignment provides the ability for the GNSS Assimilator to be “hot-plugged” into a target receiver, thereby allowing the target receiver to transition from tracking the broadcast GNSS signals to the GNSS Assimilator's signals without disruption. The synthesized signals are provided to the receiver RF input to mitigate GNSS signal obstruction or jamming. (212)

Earlier proposed techniques for improving GNSS receiver immunity to jamming and the ability to track obstructed (weak) GNSS signals share a common goal of extending the interval of time over which the GNSS receiver is able to perform coherent or non-coherent integration. In some applications, techniques are used to stabilize the receiver's reference clock, either by improved oscillator technology or by exploiting an external aiding signal. In some applications, techniques are used for eliminating the phase ambiguity caused by the navigation data modulation, whether by internal prediction of the data bits or by external data bit aiding. In some applications, techniques are used for incorporating data from inertial measurement units; techniques for implementing parallel correlation banks to reduce acquisition time. Various implementations include a combination of these techniques.

Such techniques or capabilities would generally have to be built into GNSS user equipment at the time of manufacture or would require specialized couplings to external aiding sensors or signals. In contrast, the GNSS Assimilator can be used to readily upgrade existing GNSS receivers via coupling to the target receiver through the receiver's standard RF input, without the need for special connectors or interface protocols.

The tight integration with external aiding sensors and signals happens within the Assimilator itself, upstream from the target receiver. Thus, an existing GNSS receiver can, without hardware or software modification, be upgraded with weak-signal-tracking capability and reduced susceptibility to jamming.

Another distinction between the GNSS Assimilator and earlier proposed weak-signal-tracking and jamming-robust-tracking techniques is that the Assimilator enables the target receiver to continue operating even in the absence of GNSS signals. This is because the Assimilator can synthesize GNSS signals from any source of PVT information, including non-GNSS RF signals (e.g., ELORAN and IRIDIUM™). The Assimilator extracts navigation and timing estimates from these available signals or “signals of opportunity” and can therefore withstand a blackout of all standard GNSS signals. The Assimilator thus provides the unique capability to synthesize GNSS signals on the basis of external non-GNSS PVT information, and then to phase-synchronize the synthesized signals with GNSS signals when they become available.

### Spoofing

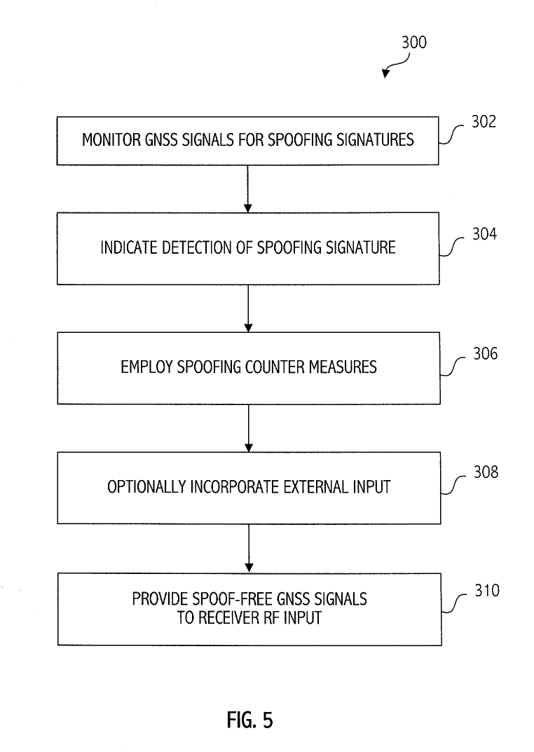

With reference to FIG. 5, a GNSS Assimilator may be used to mitigate effects of GNSS signal spoofing. One example method of countering GNSS signal spoofing is described. (300)

Incoming GNSS signals are monitored to detect one or more spoofing signatures. (302) For example, suitable detection techniques include the vestigial signal defense, the data bit latency defense, receiver autonomous integrity monitoring (“RAIM”) techniques, signal quality monitoring, and signal authentication. A RAIM module can exclude outlier data from sets of measurements from multiple satellites. Similarly, GNSS signal quality monitoring may be used to identify phenomenon, outlying data or other features of the signals that are problematic or representative of satellite failure as an indication of potential spoofing. Upon detection of a spoofing signature, an indication of spoofing may be triggered. (304) In some cases, based on the indication of spoofing, an alarm may be triggered and/or a communication connection may be established between the GNSS Assimilator and the target receiver RF input. Based on the detection and indication of spoofing, one or more spoofing countermeasures are employed. (306) For example, a reliable GNSS signal may be synthesized from diverse PVT information sources, including non-GNSS RF signals, and excluding or nullifying spoofed signal data. External input, e.g., inertial measurement unit data user input data or a time or frequency reference oscillator, may be optionally incorporated in the synthesized signals or other countermeasures employed. (308) Thus, the GNSS Assimilator can provide spoof-free synthesized GNSS signals to the target GNSS navigation receiver. (310)

The Assimilator is particularly advantageous as a retrofit to existing GNSS user equipment to provide anti-spoofing capabilities.

GPS military receivers with SAASM technology are generally hardened against spoofing, but are not generally designed to detect the presence of spoofing. Hence, the Assimilator's spoofing detection capability may also be of value to military system users.

### GNSS Modernization

The vast majority of existing civil GNSS receivers are consumer-grade single-frequency GPS receivers. The next largest class of civil receivers is survey-grade dual-frequency codeless or semi-codeless tracking GPS receivers. The hardware in these receivers cannot be practically modified to track modernized GNSS signals, causing consumers who wish to exploit the improved accuracy, availability, and redundancy of modern GNSS to declare their existing equipment obsolete and replace it with a newer model.

Likewise, many existing military GPS receivers, such as the popular DAGR, are incapable of tracking the modernized GPS military signals and would be impractical to retrofit for this purpose. The DAGR's manufacturer will no doubt recommend that military customers wishing to track modernized GPS signals replace the DAGR with modernized user equipment, at considerable expense to the military customer.

The Assimilator advantageously delivers the benefits of GNSS modernization through augmentation, rather than replacement, of both commercial and military existing user equipment. This augmentation need not require hardware or software changes to the existing equipment, and is particularly cost-effective where the Assimilator can be less expensive than replacing existing user equipment with a new model as capable as the Assimilator-receiver pair.

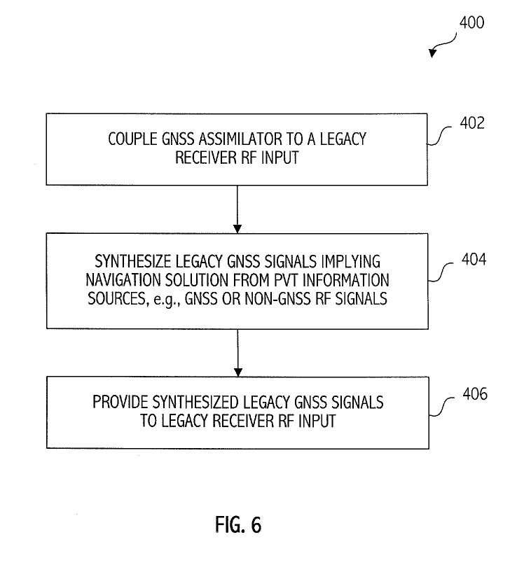

With reference to FIG. 6, in some applications, a GNSS Assimilator may be used modernize legacy GNSS receivers. One method of modernizing legacy GNSS receivers is described. (400) The GNSS Assimilator is coupled to an RF input of a legacy target receiver. (402) The coupling be via a coaxial cable between the output port of the GNSS Assimilator and the target receiver's input RF port or the coupling can be done via wireless RF transmission of the GNSS signals from the GNSS Assimilator transmit antenna to the target receiver receive antenna. The GNSS Assimilator synthesizes legacy receiver-compliant GNSS signals from a range of PVT information sources, e.g., GNSS or non-GNSS RF signals, or other sources. (404) The legacy receiver compliant GNSS signals define a navigation and/or timing solution. For example, if the target receiver can only track the legacy GPS L1 C/A code signals, the GNSS Assimilator only needs to synthesize GPS L1 C/A signals. The Assimilator, however, can provide improved accuracy in the synthesized GPS L1 C/A code signals by removing ranging error sources by tracking newer GPS L2C or L5 signals or other non-GNSS signals. Tracking signals from frequencies other than GPS L1 provides the ability to remove ionospheric ranging errors, and tracking more precise ranging signals such as GPS L5 can help identify and removing multipath ranging errors. The legacy receiver compliant GNSS signals are provided to the RF input of the legacy target receiver. (406)

Once a navigation solution is obtained from one or more of the observables above, the navigation solution (i.e., position, velocity, and time) is input into a GNSS signal simulator to generate radio-frequency GNSS signals defining or implying a navigation solution consistent with the navigation solution rendered from one or more of the observables above. These simulated GNSS signals can be input into an existing compatible GNSS receiver.

A number of embodiments of the invention have been described. Nevertheless, it will be understood that various modifications may be made without departing from the spirit and scope of the invention. For example, any number or combination of spoofing detection techniques can be employed simultaneously or sequentially. Similarly, any number of GNSS or non-GNSS signals can be used to synthesize a reliable navigation signal. Accordingly, other embodiments are within the scope of the following claims.

What is claimed is:

1. A method for generating a set of radio-frequency (RF) GNSS signals, the method comprising:
receiving a plurality of RF signals, each signal bearing one or more navigation or timing usable observables;
estimating a first navigation solution based on the observables from the plurality of signals; and
generating a plurality of simulated radio-frequency GNSS signals defining a second navigation solution substantially consistent with the first navigation solution.

2. The method of claim 1, wherein the one or more observables comprises at least one of a code phase, carrier phase, carrier frequency, navigation data bit sequence phase, and correlation function profile.

3. The method of claim 1, wherein at least one of the plurality of signals is a non-GNSS signal.

4. The method of claim 3, wherein the one or more observables includes at least one of signal time-of-arrival, signal angle-of-arrival, carrier frequency, and data bit sequence phase.

5. The method of claim 1, further comprising receiving at least one of position, velocity, and acceleration observables from a local inertial measurement unit for use in at least one of the estimating and the generating.

6. The method of claim 1, wherein the second navigation solution is obtained using an estimator routine to fuse at least one of the one or more GNSS observables and one or more non-GNSS observables.

7. The method of claim 1, further comprising relating an antenna position, velocity and receiver time to at least one of a GNSS observable and a non-GNSS observable.

8. The method of claim 1, further comprising inputting the simulated GNSS signal into a GNSS receiver.

9. The method of claim 1, wherein the plurality of signals includes exclusively non-GNSS signals.

10. The method of claim 1, further comprising aligning at least one of a carrier phase and a code phase of the synthesized GNSS signal with a respective one of a carrier phase and a code phase of one or more ambient radio-frequency GNSS signals at a predetermined three-dimensional position offset and a predetermined velocity offset relative to a predetermined antenna reference location.

11. The method of claim 1, further comprising compensating, with the synthesized GNSS signals, for at least one of a jammed GNSS signal, a weak GNSS signal, a counterfeit GNSS signal, and a compromised GNSS signal.

12. The method of claim 1, further comprising receiving a baseband signal bearing at least one of time, position and velocity data wherein the baseband signal comprises one of an inertial navigation system signal, a time reference signal, a frequency reference signal, and a user input.

13. The method of claim 1, wherein an output signal is compliant with a target dedicated GNSS receiver.

14. The method of claim 1, wherein the assimilator is integrated into a GNSS receiver.

15. A GNSS signal assimilator comprising:
a signal receiver configured to receive a plurality of RF signals and extract at least one code observable corresponding to each of the plurality of signals;
a navigation and timing fusing module configured to render, from the code observables, time and position data, and to calculate a first navigation solution based on the rendered data; and
a signal simulator module configured to synthesize a plurality of GNSS signals that collectively define a second navigation solution substantially consistent with the first navigation solution.

16. The GNSS signal assimilator of claim 15, wherein the GNSS signal receiver is a multi-system receiver module configured to receive a non-GNSS signal and wherein the navigation and timing fusion module is configured to render time, position, or velocity data from the non-GNSS signal.

17. The GNSS signal assimilator of claim 15, wherein the navigation and timing fusion module is configured to render a navigation solution using time, position or velocity data rendered exclusively from one or more non-GNSS signals.

18. The GNSS signal assimilator of claim 15, wherein the one or more non-GNSS signals includes at least one of a television signal, communications network signal, HDTV signal, LORAN signal, ELORAN signal, Radar signal, and IRIDIUM™ signal.

19. The GNSS signal assimilator of claim 15, further comprising an RF output and wherein the synthesizing module is configured to output the second navigation solution as an RF GNSS signal.

20. The GNSS signal assimilator of claim 19, further configured to align at least one of a carrier phase and a code phase of the synthesized GNSS signal with a respective carrier phase and code phase of one or more ambient radio-frequency GNSS signals at a predetermined three-dimensional position offset and a predetermined velocity offset relative to a predetermined assimilator reference location.

21. The GNSS signal assimilator of claim 19, further comprising an anti-spoofing module operable to continuously analyze data received at the GNSS signal receiver to detect potential spoofing via one of a data bit latency, a vestigial signal, a signal angle-of-arrival, a signal angle-of-arrival measured by multiple antennae, RAIM outlier data, signal quality deterioration, and a cryptographic signature.
